(19) United States
(12) Patent Application Publication
(10) Pub. No.: US 2011/0094062 A1
(43) Pub. Date: Apr. 28, 2011

(54) HANDLE WITH DEFORMABLE CUSHION FOR CULINARY ARTICLE

(75) Inventor: Ludovic PASQUINI, Annecy (FR)

(73) Assignee: SEB S.A., Ecully (FR)

(21) Appl. No.: 12/912,980

(22) Filed: Oct. 27, 2010

(30) Foreign Application Priority Data
Oct. 27, 2009 (FR) 09 05156

(51) Int. Cl. B25G 1/10

(52) U.S. Cl. 16/430

(57) ABSTRACT

A culinary article handle composed of a rigid body connected to the culinary article and at least one deformable cushion, or pad, wherein the cushion includes a silicone or thermoplastic skin designed to be in contact with the hand, the skin defining a receptacle, and a solid core having a Shore A hardness less than the Shore A hardness of the silicone skin, fixed in the receptacle.

### BACKGROUND OF THE INVENTION

The present invention relates to a handle for a culinary article such as a pot, a sauce pan, a frying pan, etc.

The patent document EP0742083 discloses a handle having a rigid structure and inserts overmolded on the structure. These inserts are positioned on the rigid structure in the areas where the fingers are placed. The inserts have a Shore A hardness less than 60, preferably 50.

A handle construction with an insert of such hardness does not allow actual deformation of the insert needed for adaptation to the shape of the user's hand when grasping and manipulating the handle.

For a real deformation of the insert, the Shore A hardness of the insert must be less than 20. However, an insert having such a hardness ages rapidly due to its fragility in the face of impacts with other utensils or due to stresses from cleaning pads or dishwashers.

### BRIEF SUMMARY OF THE INVENTION

The present invention overcomes the above drawbacks and provides a handle for a culinary article with greater comfort and optimized ergonomics that allow for adaptation of the shape of the handle to the shape of the user's hand.

The invention also provides a handle for a culinary article that is durable over time, is of simple design and is economical to fabricate.

These goals are achieved with a culinary article handle comprising a rigid body connected to the culinary article and at least one deformable cushion, or pad, wherein the cushion includes a silicone skin designed to be in contact with the hand, the skin defining a receptacle containing a solid core with a Shore A hardness less than the hardness of the skin.

In other words, there is obtained a handle presenting locally a sandwich structure of a cushion skin, soft core and rigid body. Thus, when gripping the handle, the skin and core deform under the pressure of the hand. This deformation allows an adaptation of the shape of the handle to the hand, or at least the thumb, shape, which improves handling and comfort of the handle.

Preferably, the silicone skin has a Shore A hardness between 30 and 60, preferably 50.

This silicone skin has the advantage of having good mechanical strength and providing an agreeable feel and grip. By good strength, is meant a resistance to breakage due to impacts with other utensils or scratching or wear from attacks by cleaning pads.

Preferably, the core has a Shore A hardness between 3 and 20, preferably 5.

Preferably, the core has a thickness between 2 and 8 millimeters, preferably 5 mm.

These provisions allow a real deformation of the core greater than one millimeter to allow adaptation of the shape of the handle to the shape of the hand and thus to obtain a comfortable feeling.

Preferably, the silicone skin has a thickness of between half a millimeter and two millimeters, preferably one millimeter.

This will ensure good flexibility of the skin, while ensuring good strength.

Preferably, the cushion is fixed in a receiving cavity provided on the outer surface of the rigid body.

This arrangement provides a handle whose outer surface has no protuberance, detrimental to gripping. Moreover, this type of flush mounting of the core and skin in a cavity in the handle ensures a good retention of the cushion.

Preferably, the cushion is fixed, or attached, in the receiving cavity by bonding, cementing, etc.

This arrangement provides an intimate connection between the cushion and the handle and thus avoids penetration and retention of water or other contaminants in the attachment area.

Preferably, the skin of the pad has a substantially flat wall in contact with the hand and a peripheral wall extending transversely to the flat wall.

This provision allows the skin of the cushion to have the form of a receptacle into which the liquid material of the core may be poured before it hardens.

Preferably, the silicone skin of the pad is translucent.

This provision allows the color of the core to be viewed through the skin that serves as protection against possible attacks during the use of the culinary article. Thus, the color of the cushion will be maintained over time.

Preferably, the cushion has a bottom wall.

The core and/or skin may be made of a variety of thermoplastic materials, for example of the elastomer or SEBS type, in place of silicone.

### BRIEF DESCRIPTION OF THE DRAWINGS

FIG. 1 illustrates a perspective view of a handle for a culinary article according to a particular embodiment of the invention.

FIG. 2 shows a cross-section along the line II-II of the handle of FIG. 1.

FIG. 3 shows a perspective view of only the cushion of the handle of FIG. 1.

FIG. 4 shows a cross-section along the line IV-IV of the cushion of FIG. 3.

FIG. 5 illustrates a perspective view of a handle for a culinary article according to another embodiment of the invention.

FIG. 6 illustrates a cross-section along the line VI-VI of the handle of FIG. 5.

### DETAILED DESCRIPTION OF THE INVENTION

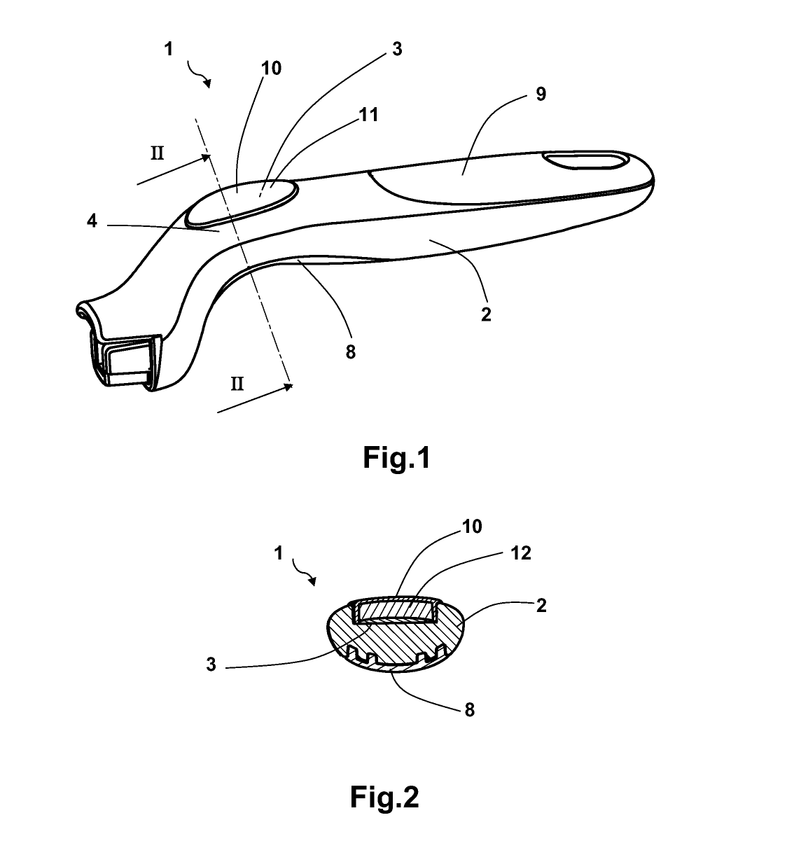

FIG. 1 shows a handle for a culinary article such as a pot, or sauce pan, or frying pan. The culinary article and attachment of the handle on the culinary article are made in a manner known per se and are not represented.

The handle 1 comprises an elongated body 2 of substantially oval cross-section. The body 2 of the handle 1 is molded in a material such as “Bakelite®”. The body 2 comprises an upper front part 4 comprising a cushion 10 facing the support zone for the thumb when the handle is gripped.

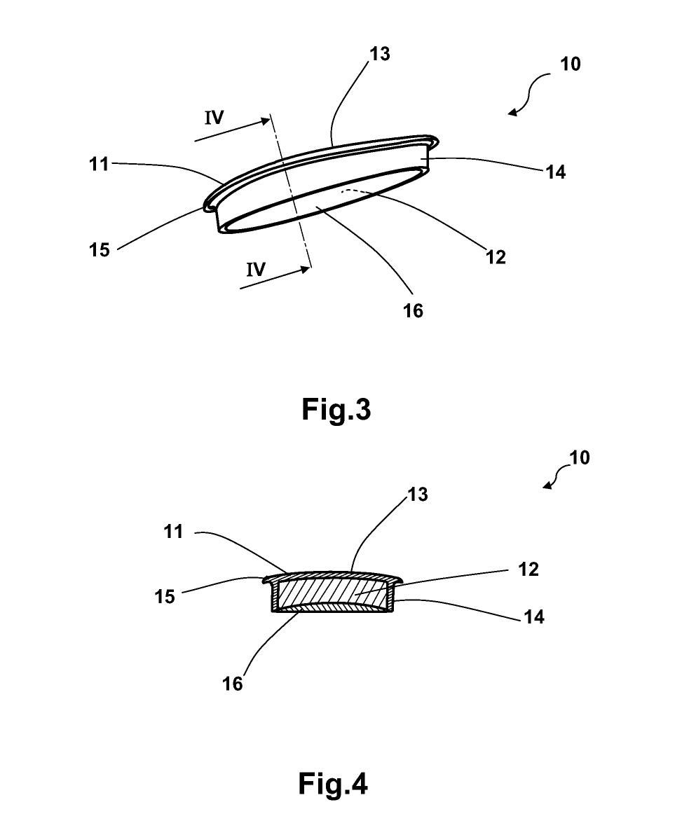

As seen in FIGS. 3 and 4, the cushion 10 has an oval form of substantially rectangular cross section. The cushion 10 includes a silicone skin 11 and a core 12.

The skin 11 of cushion 10 includes a slightly curved, but substantially planar, wall 13 of oval form, locate to be in contact with the user's hand, and specifically the user's thumb, and a peripheral wall 14 slightly recessed, or set back, from the periphery of the oval form of wall 13 and extending transversely to the substantially flat wall 13. Around the peripheral wall 14, a lip 15 is provided on the periphery of the substantially flat wall 13. The silicone skin 11 preferably has a Shore A hardness of 50 and a thickness of about one millimeter.

The skin 11 of the cushion 10 thus forms a receptacle. To make the cushion 10, the receptacle is filled with a liquid silicone that will set over time to form the core 12. The goal is to get a solid core 12 of a Shore A hardness preferably of five and a thickness of about five millimeters, defined by the height of the peripheral wall 14.

During drying, the surface formed by the liquid silicone in contact with the air, will not remain flat and a slight depression will be created in its center. According to an embodiment of the core 12, filling of this depression is made with the same type of liquid silicone to form a flat bottom wall 16 after curing.

Such a cushion 10 made entirely of silicone provides a temperature resistance up to about 220° C., close to the heat resistance of the handle body 2 of “Bakelite®” which is about 230° C. In use, the cushion will reach a temperature of is less than 70° C., thus ensuring good durability of the handle.

As seen in FIGS. 1 and 2, the body 2 of the handle 1 comprises in its upper front part 4 a cavity 3 located opposite, or facing, the support zone for the user's thumb. The cushion 10 is fixed in this cavity 3 by cementing, bonding, etc.

The cavity 3 is dimensioned to receive the external shape of the cushion 10 without leaving a free space that could accommodate liquids or other contaminants. The lip section 15 which tapers towards the outside wall 13 provides a planar junction without irregularities, or unevenness, between the body 2 of the handle and the cushion 10 and reinforces the liquid tightness of the assembly.

The cavity 3 has a flat bottom that receives without any play the bottom wall 16 of the cushion. Thus, during pressing of the finger on the cushion, the deformation of the skin and the core causes a pleasurable sensation that is not disturbed by other extraneous deformations of the type that might be produced by air bubbles that may have been trapped.

The flat wall 13 of the pad has a surface area of about 400 square millimeters, which offers an excellent compromise between a real deformation of the cushion for comfort and good grip. This corresponds roughly to the bearing surface of the thumb on the handle during gripping of the culinary article.

Preferably, the silicone of core 12 is colored and the skin 11 in the silicone pad 10 is translucent. This allows the color of the core 12 to be seen while ensuring its protection. The bottom wall 16 may be colored white, which preserves the visual color appearance of the core 12. In effect, since the core material is not completely opaque, this white bottom wall 16 prevents the color of the body 2 of the handle from altering the color of the core 12 as perceived by the user.

To improve gripping of the handle, silicone inserts 8, 9 are added to the body 2 of the handle by cementing or overmolding.

In one embodiment, the inserts 8, 9 are replaced by cushions according to the invention.

In use, the user grasps the handle by placing his or her thumb on the pad 10. When grasping the handle, the pressure exerted by the thumb on the pad 10 deforms the silicone skin 11 and core 12, thereby improving the comfort provided by the handle.

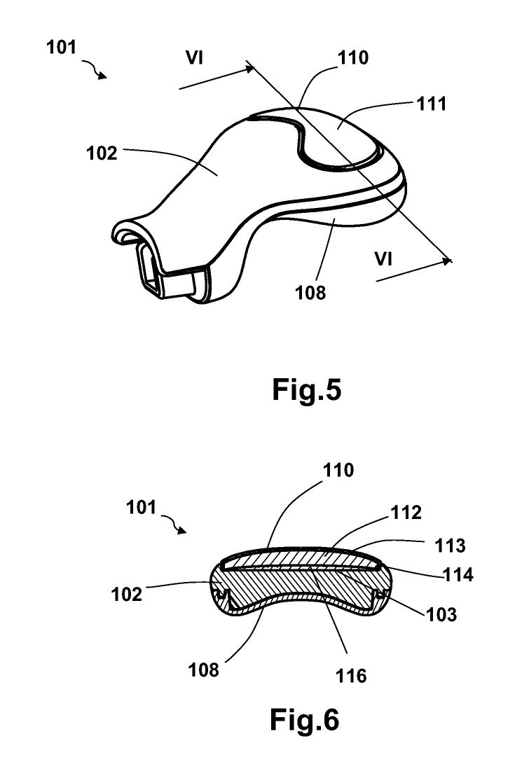

FIGS. 5 and 6 illustrate another embodiment of the invention and relate to a handle 101 for a saucepan or stewpot. This type of culinary article generally includes a container equipped in its upper outer part with two diametrically opposed handles: one right and one left.

The handle 101 comprises a body 102 having an upper portion including a cushion 110 disposed facing the support zone for the thumb when gripping handle 101. The cushion 110 has an oval shape of approximately rectangular cross section arranged transversely to the handle. This permits obtaining identical right and left handles, one part of the cushion receiving the right thumb for the right handle and the other part receiving the left thumb for the left handle.

The cushion 110 has a structure identical to the cushion 10 and includes a skin 111 of silicon and a core 112. The skin 111 of cushion 110 comprises a slightly curved, but substantially planar, wall 113 in contact with the hand and a peripheral wall 114. The cushion has a bottom wall 116.

The body 102 of the handle 101 comprises in its upper part a cavity 103 facing the support zone for the thumb. The cushion 110 is fixed in the cavity 103 by cementing.

To improve holding in the hand, a silicone insert 108 is added to the body 102 of the handle by cementing or overmolding.

This application relates to subject matter disclosed in French Application Number 09 05156, filed on Oct. 27, 2009, the disclosure of which is incorporated herein by reference.

Of course, the invention is not limited to the embodiment described and illustrated which has been given as an example. Modifications remain possible, particularly in terms of the constitution of the various elements or by substitution of technical equivalents, without departing from the scope of protection of the invention.

Thus in one embodiment of the invention, the core can be overmolded into the handle body and the skin in contact with the hand is attached either by another overmolding operation, or by cementing.

What is claimed is:

1. A culinary article handle comprising:
a rigid body connectable to the culinary article; and
at least one deformable cushion,
wherein said cushion comprises a silicone or thermoplastic skin located and adapted to be in contact with a user's hand, said skin having a first Shore A hardness and defining a receptacle, and a solid core filling said receptacle and having a second Shore A hardness that is lower than the first Shore A hardness.

2. The culinary article handle of claim 1, wherein said skin and said core are made of silicone.

3. The culinary article handle of claim 2, wherein said silicone skin has a Shore A hardness between 30 and 60.

4. The culinary article handle of claim 3, wherein said silicone skin has a Shore A hardness of at least approximately 50.

5. The culinary article handle of claims 3, wherein said core has a Shore A hardness between 3 and 20

6. The culinary article handle of claim 5, wherein said silicone skin has a Shore A hardness of at least approximately 5.

7. The culinary article handle of claim 5, wherein said core has a thickness between 2 and 8 mm,

8. The culinary article handle of claim 7, wherein said core has a thickness of 5 at least approximately mm.

9. The culinary article handle of claim 7, wherein said silicon skin has a thickness between half a millimeter and two millimeters

10. The culinary article handle of claim 9, wherein said silicon skin has a thickness of at least approximately one millimeter.

11. The culinary article handle of claim 9, wherein said cushion is fixed in a cavity provided on the external surface of said rigid body.

12. The culinary article handle of claim 11, wherein said cushion is set in said cavity by cementing.

13. The culinary article handle of claim 12, wherein said skin has a substantially plane wall located to be in contact with a user's hand and a peripheral wall extending transversely to said plane wall to form a receptacle.

14. The culinary article handle of claim 13, wherein said silicone skin translucent.

15. The culinary article handle of claim 14, wherein said cushion has a bottom wall.

16. The culinary article handle of claims 2, wherein said core has a Shore A hardness between 3 and 20

17. The culinary article handle of claim 16, wherein said silicone skin has a Shore A hardness of at least approximately 5.

18. The culinary article handle of claim 2, wherein said core has a thickness between 2 and 8 mm,

19. The culinary article handle of claim 18, wherein said core has a thickness of at least approximately 5 mm.

20. The culinary article handle of claim 2, wherein said silicon skin has a thickness between half a millimeter and two millimeters

21. The culinary article handle of claim 20, wherein said silicon skin has a thickness of at least approximately one millimeter.

22. The culinary article handle of claim 2, wherein said cushion is fixed in a cavity provided on the external surface of said rigid body.

23. The culinary article handle of claim 22, wherein said cushion is set in said cavity by cementing.
